(19) United States
(12) Patent Application Publication
(10) Pub. No.: US 2020/0028978 A1
(43) Pub. Date: Jan. 23, 2020

(54) IMAGE FORMING APPARATUS

(71) Applicant: KYOCERA Document Solutions Inc., Osaka (JP)

(72) Inventor: Masayuki TOBINAGA, Osaka (JP)

(73) Assignee: KYOCERA Document Solutions Inc., Osaka (JP)

(21) Appl. No.: 16/513,100

(22) Filed: Jul. 16, 2019

(30) Foreign Application Priority Data
Jul. 20, 2018 (JP) 2018-136914

(51) Int. Cl. H04N 1/00; H04N 1/32; G06K 9/00

(52) U.S. Cl. CPC H04N 1/00328; H04N 1/32037; G06K 2209/01; G06K 9/00469; H04N 2201/0094; G06K 9/00463

(57) ABSTRACT

An image forming apparatus includes an image reader unit that reads a document so as to generate image data, a storage unit that stores a user name and an address associated with the user name, a control unit that performs a character recognition process on the image data so as to obtain text data from the image data, recognizes a word included in the text data, and sets the address associated with the user name matching the recognized word to a destination, and a communication unit that transmits the image data to the destination set by the control unit.

### INCORPORATION BY REFERENCE

This application is based upon and claims the benefit of priority from the corresponding Japanese Patent Application No. 2018-136914 filed Jul. 20, 2018, the entire contents of which are hereby incorporated by reference.

### BACKGROUND

The present disclosure relates to an image forming apparatus that reads a document so as to transmit image data of the document.

Conventionally, there is known an image forming apparatus that can execute a transmission job. For instance, a conventional image forming apparatus that can execute a transmission job includes an image reader unit that reads a document. The image reader unit reads a document so as to generate image data. Further, the conventional image forming apparatus executes the transmission job, i.e. a job of transmitting the image data to an external device.

As the image forming apparatus that can execute the transmission job, there is a facsimile machine, for example. The facsimile machine receives various settings such as destination setting from a user before executing the transmission job.

### SUMMARY

An image forming apparatus according to one aspect of the present disclosure includes an image reader unit, a storage unit, a control unit, and a communication unit. The image reader unit reads a document so as to generate image data. The storage unit stores a user name and an address associated with the user name. The control unit performs a character recognition process on the image data so as to obtain text data from the image data, recognizes a word included in the text data, and sets an address associated with the user name matching the recognized word to a destination. The communication unit transmits the image data to the destination set by the control unit.

### BRIEF DESCRIPTION OF THE DRAWINGS

FIG. 1 is a block diagram illustrating a structure of a multifunction peripheral according to one embodiment of the present disclosure.

FIG. 2 is a diagram illustrating a structure of an image reader unit of the multifunction peripheral according to the one embodiment of the present disclosure.

FIG. 3 is a flowchart showing a flow of a process performed by a control unit of the multifunction peripheral according to the one embodiment of the present disclosure.

FIG. 4 is an explanatory diagram of a first process performed by the control unit of the multifunction peripheral according to the one embodiment of the present disclosure.

FIG. 5 is an explanatory diagram of a second process performed by the control unit of the multifunction peripheral according to the one embodiment of the present disclosure.

FIG. 6 is an explanatory diagram of a third process performed by the control unit of the multifunction peripheral according to the one embodiment of the present disclosure.

### DETAILED DESCRIPTION

Hereinafter, one embodiment of the present disclosure is described with an example of a multifunction peripheral having a plurality of basic functions such as a copy function and a transmission function.

<Overall Structure of Multifunction Peripheral>

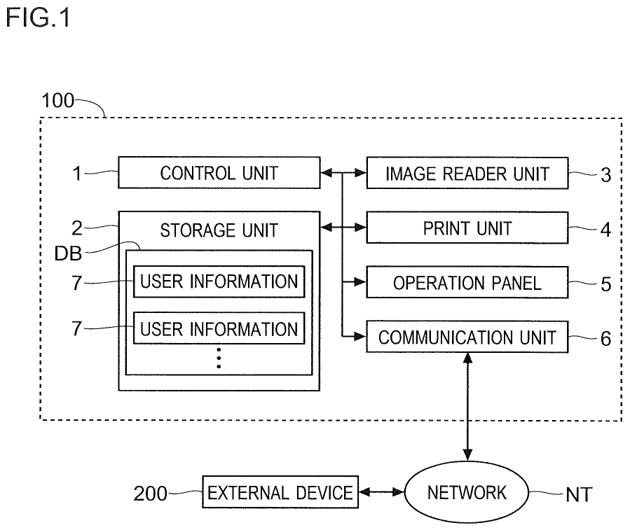

As illustrated in FIG. 1, a multifunction peripheral 100 (corresponding to an “image forming apparatus”) of this embodiment includes a control unit 1. The control unit 1 includes a CPU. The control unit 1 controls individual portions of the multifunction peripheral 100 based on a control program and control data.

In addition, the multifunction peripheral 100 includes a storage unit 2. The storage unit 2 includes storage devices such as a ROM, a RAM and an HDD. The storage unit 2 stores a control program and control data. The storage unit 2 is connected to the control unit 1. The control unit 1 reads information from the storage unit 2 and writes information into the storage unit 2.

Note that character recognition software (OCR software) is installed in the multifunction peripheral 100 in advance. The character recognition software is stored in the storage unit 2. The control unit 1 performs the character recognition process based on the character recognition software.

In addition, the multifunction peripheral 100 includes an image reader unit 3. The image reader unit 3 is connected to the control unit 1. The control unit 1 controls reading operation of the image reader unit 3.

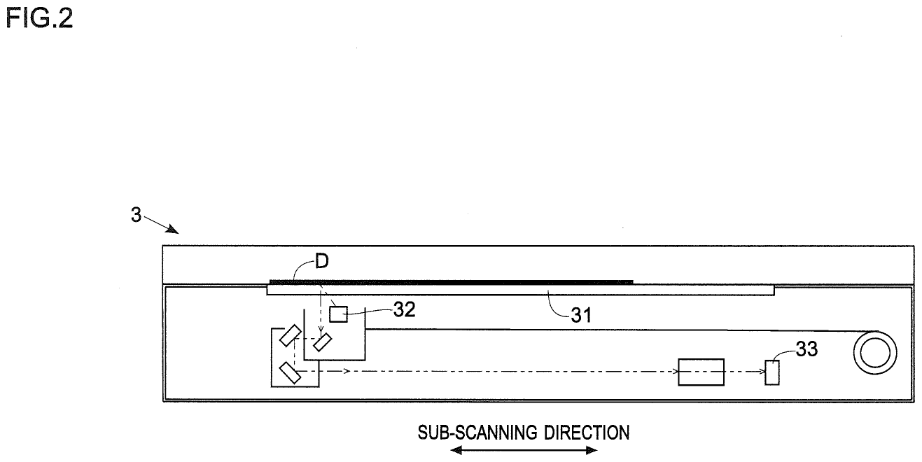

As illustrated in FIG. 2, the image reader unit 3 includes a platen glass 31. The image reader unit 3 optically reads a document D set on the platen glass 31 so as to generate image data of the read document D. The image reader unit 3 includes a light source 32 and an image sensor 33. The light source 32 emits light to the document D on the platen glass 31. The image sensor 33 receives reflected light reflected by the document D and performs photoelectric conversion. FIG. 2 shows the light emitted from the light source 32 and reflected by the document D by a double dot-dashed line.

With reference to FIG. 1 again, the multifunction peripheral 100 includes a print unit 4. The print unit 4 conveys a paper sheet and prints an image on the paper sheet that is being conveyed. The print method of the print unit 4 may be an inkjet type or may be a laser type. The print unit 4 is connected to the control unit 1. The control unit 1 controls printing operation of the print unit 4.

If the print method of the print unit 4 is an inkjet type, the print unit 4 is equipped with an ink head. The inkjet type print unit 4 ejects ink to the paper sheet that is being conveyed so that the ink is attached to the paper sheet. If the print method of the print unit 4 is a laser type, the print unit 4 is equipped with a photosensitive drum, a charging device, a developing device, an exposing device, and a transfer roller. The laser type print unit 4 develops an electrostatic latent image corresponding to the image to be printed into a toner image, and transfers the toner image onto the paper sheet that is being conveyed.

In addition, the multifunction peripheral 100 is equipped with an operation panel 5. The operation panel 5 includes a touch screen and hardware buttons. The operation panel 5 is connected to the control unit 1. The control unit 1 controls display operation of the operation panel 5. In addition, the control unit 1 detects an operation performed to the operation panel 5.

The touch screen displays a screen in which software buttons, a message, and the like are arranged, and receives a user's operation to a display screen (software button). A plurality of hardware buttons are disposed on the operation panel 5. The hardware buttons include a start button for receiving a user's instruction to execute a job.

In addition, the multifunction peripheral 100 includes a communication unit 6. The communication unit 6 is an interface for connecting the multifunction peripheral 100 to a network NT such as the Internet line and a telephone line. The communication unit 6 includes a LAN communication circuit for LAN communication, a FAX communication circuit for FAX communication, and the like.

The communication unit 6 is connected to the control unit 1. The control unit 1 controls the communication unit 6 so as to communicate with an external device 200 connected to the network NT. A personal computer, a facsimile machine, and the like as the external devices 200 are connected to the network NT. The control unit 1 communicates with the external device 200 and performs a transmission job of transmitting data to the external device 200. For instance, in the transmission job, the image data of the document D read by the image reader unit 3 can be transmitted to the external device 200. In addition, electronic mail attached with image data of the document D read by the image reader unit 3 can be transmitted to the external device 200.

<Transmission Job>

For instance, the operation panel 5 displays a screen for receiving user's selection of a function to be used among a plurality types of basic functions of the multifunction peripheral 100, as a home screen (not shown). A plurality of software buttons respectively corresponding to the plurality types of basic functions are arranged on the home screen.

When detecting an operation to the software button corresponding to the transmission function, the control unit 1 controls the operation panel 5 to display a transmission setting screen (not shown) for receiving setting of the transmission job from the user. By displaying the transmission setting screen on the operation panel 5, various settings about the transmission job such as setting of a destination (address) can be performed.

For instance, when setting a destination, a software keyboard is displayed on the operation panel 5. Thus, an address is input with the software keyboard, and the address input with the software keyboard is set to a destination. Alternatively, an address book (a list screen of registered addresses as choices) is displayed on the operation panel 5, and a desired address is selected from the address book, so that the address selected from the address book is set to the destination.

When detecting an operation to the start button during the display of the transmission setting screen, the control unit 1 determines that the operation panel 5 has received an instruction to execute the transmission job. When the operation panel 5 has received the instruction to execute the transmission job, the control unit 1 recognizes the address input to the transmission setting screen as a destination designated by the user. In addition, the control unit 1 controls the image reader unit 3 to read the document D. Further, the control unit 1 controls the communication unit 6 to transmit the image data obtained by reading by the image reader unit 3 to the destination designated by the user.

Here, it is tiresome and is not convenient for the user to input an address with the software keyboard or to select an address from the address book for setting the destination. In addition, if the user is not accustomed to using the multifunction peripheral 100, it may take time to set the destination.

Therefore, the multifunction peripheral 100 has an automatic setting function of automatically setting the destination. Using the automatic setting function, it is not necessary to set the destination on the transmission setting screen. In this way, convenience for users is improved.

The automatic setting function can be arbitrarily set to be enabled or disabled by a user. The operation panel 5 receives from the user the setting for enabling or disabling the automatic setting function. When the operation panel 5 receives the setting to enable the automatic setting function, the control unit 1 sets the automatic setting function to be enabled. Further, in this state, when the operation panel 5 receives an instruction to execute the transmission job, the control unit 1 performs the process of automatically setting the destination as one process of a job process about the transmission job.

In order to use the automatic setting function, it is necessary for the user to register his or her user name in advance. The operation panel 5 receives the registration of the user name from the user. When receiving the registration of the user name, the operation panel 5 receives setting of an address to be associated with the user name from the user. When receiving the setting of the address to be associated with the user name, the operation panel 5 displays the software keyboard. Alternatively, the operation panel 5 displays the address book.

The control unit 1 associates the user name with the address input from the software keyboard or the address selected from the address book. Further, the control unit 1 controls the storage unit 2 to store information including the user name and the address associated with the user name as user information 7 to be used for the automatic setting of the destination (see FIG. 1). The user information 7 is stored in a database DB.

In an environment where a plurality of users use the multifunction peripheral 100, the plurality of users can individually register their user names. When the plurality of users individually register their user names, the control unit 1 controls the storage unit 2 to store the user information 7 for each of the user names. Note that the user can associate the plurality of addresses with his or her user name. In addition, the user can associate his or her address with his or her user name, or can associate other person's address with the same.

When the automatic setting function is enabled, the address included in the user information 7 is a candidate of the destination to be set. Therefore, it is necessary to register the user information 7 including the user name associated with the address in advance.

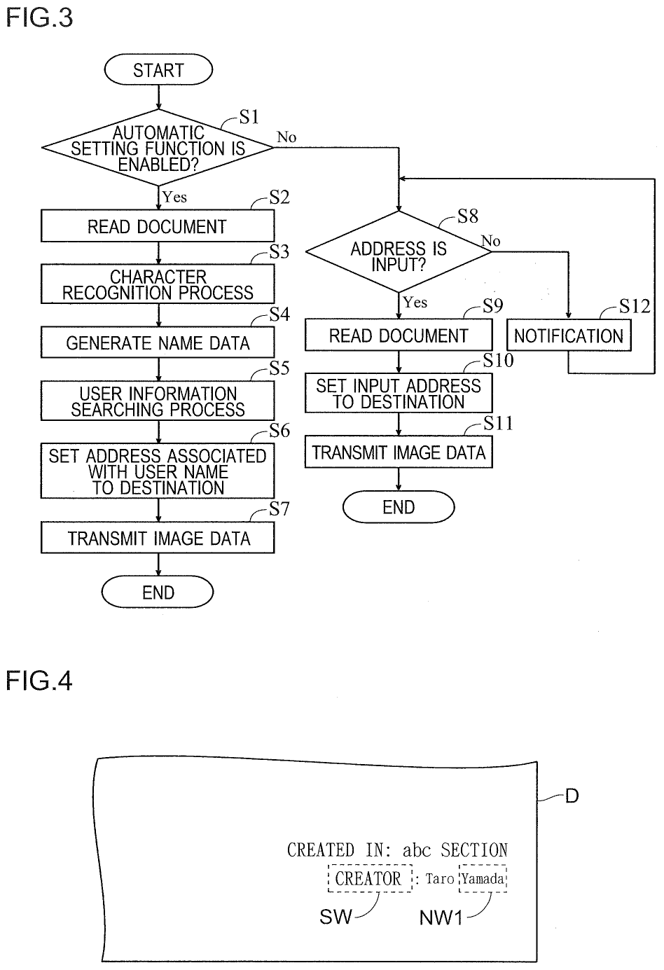

Hereinafter, with reference to the flowchart shown in FIG. 3, a flow of a job process concerning the transmission job performed by the control unit 1 is described. It is supposed that the transmission setting screen is displayed on the operation panel 5 at a start time point of the flowchart shown in FIG. 3. In this state, when the control unit 1 detects an operation to the start button, the flowchart shown in FIG. 3 starts.

In Step S1, the control unit 1 determines whether or not the automatic setting function is enabled. As a result, if the control unit 1 determines that the automatic setting function is enabled, the process flow proceeds to Step S2.

In Step S2, the control unit 1 instructs the image reader unit 3 to perform reading. When receiving the instruction to perform reading, the image reader unit 3 reads the document D so as to generate image data of the document D. The control unit 1 obtains the image data of the document D as an object to be transmitted.

In Step S3, the control unit 1 performs the character recognition process on the image data of the document D based on the OCR software. The control unit 1 performs the character recognition process so as to obtain text data from the image data of the document D.

In Step S4, the control unit 1 performs morphological analysis on the text data obtained in the process of Step S3 so as to divide the text data, and recognizes words included in the text data. In addition, the control unit 1 uses dictionary data stored in the storage unit 2 in advance, so as to identify parts of speech of the words included in the text data. Further, the control unit 1 generates name data in which words whose part of speech is a noun (name) are listed.

In Step S5, the control unit 1 performs a user information searching process of searching the database DB stored in the storage unit 2 for the user information 7 including the user name that matches one of words (names) listed in the name data (hereinafter this user information 7 is referred to as target user information 7). The control unit 1 performs one of a first process, a second process, and a third process, as the user information searching process. For instance, the user sets which one of the first process, the second process, and the third process should be performed. This operation panel 5 receives this setting from the user.

Here, the first process, the second process, and the third process are described. In the following description, it is supposed that a word “Yamada” is registered as the user name (the user information 7 including the word “Yamada” as the user name is stored in the storage unit 2), as an example.

1. First Process

In the first process, the control unit 1 searches the text data for a specific word so as to recognize the specific word included in the text data. In other words, the control unit 1 searches for (recognizes) a word matching the specific word among words listed in the name data. Specific word information indicating the specific word is stored in the storage unit 2 in advance. The user can arbitrarily add or delete the specific word. The operation panel 5 receives the addition or deletion of the specific word from the user.

The specific word is a word for a destination person to recognize the user who is a data sender. For instance, words such as “sender”, “creator”, and “clerk” are specific words. In general, as shown in FIG. 4, the specific word is written on the same line as the user name of the data sender. In FIG. 4, the specific word is denoted by symbol SW, and the word corresponding to the user name is denoted by symbol NW1. In addition, the specific word SW and the word NW1 are respectively enclosed by broken lines.

When finding the specific word in the words listed in the name data, the control unit 1 recognizes the word on the same line as the specific word. In addition, the control unit 1 searches the database DB for a user name matching the word on the same line as the specific word. Further, the control unit 1 recognizes the user information 7 including a user name matching the word on the same line as the specific word as the target user information 7.

In the example shown in FIG. 4, there is the word NW1 “Yamada” on the same line as the specific word SW “creator”. In this case, the user information 7 including a user name matching the word NW1 is recognized as the target user information 7. In other words, the user information 7 corresponding to the user having the name “Yamada” is recognized as the target user information 7.

Although not illustrated, if another word is also on the same line as the specific word SW in addition to the word NW1, and if there is the user information 7 including the another word as a user name, the user information 7 including the another word is also recognized as the target user information 7.

2. Second Process

When performing the second process, the control unit 1 searches the image data of the document D for a ruled line frame. In addition, the control unit 1 searches for a word that is listed in the name data and is inside the ruled line frame, so as to recognize the word inside the ruled line frame. In the following description, this word is referred to as an in-frame word.

When finding the in-frame word, the control unit 1 searches the database DB for a user name matching the in-frame word. Further, the control unit 1 recognizes the user information 7 including the user name matching the in-frame word as the target user information 7.

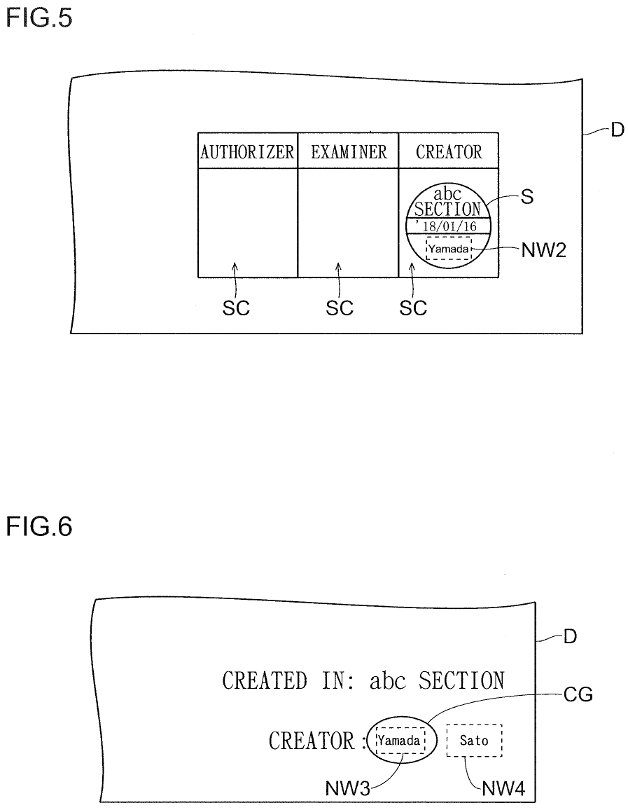

Here, as shown in FIG. 5, a seal space area SC may be printed in the document D corresponding to the image data to be transmitted. In general, the seal space area SC is defined by a plurality of ruled lines arranged in a matrix. In other words, the seal space area SC is constituted of a ruled line frame (the inside of the ruled line frame is the seal space area SC). When performing the transmission job of this document D as an object to be read, the user puts his or her seal (such as a name seal) in the seal space area SC (inside the ruled line frame) before performing the transmission job. FIG. 5 shows an example of the document D having three seal space areas SC, in one of which a seal S including a word NW2 “Yamada” is put. In addition, the word NW2 is enclosed by a broken line.

In the example shown in FIG. 5, the word NW2 is inside the ruled line frame, and hence the word NW2 is extracted as the in-frame word. In addition, among words included in the seal S, each word other than the word NW2 is also extracted as the in-frame word. Further, each of the words “authorizer”, “examiner” and “creator” is also inside the ruled line frame, and hence each of the words is also extracted as the in-frame word. However, each of the words other than the word NW2 is not a user name and is not registered as a user name. In this case, the user information 7 including the user name matching the word NW2 is recognized as the target user information 7. In other words, the user information 7 corresponding to the user having the name “Yamada” is recognized as the target user information 7.

3. Third Process

When performing the third process, the control unit 1 searches the image data of the document D for a check image. For instance, the check image is a circular (or an elliptical) frame image. In addition, the control unit 1 searches for a word that is listed in the name data and is accompanied with the check image (enclosed by the check image), and recognizes the word accompanied with the check image. In the following description, this word is referred to as a word with check.

When finding the word with check, the control unit 1 searches the database DB for a user name matching the word with check. Further, the control unit 1 recognizes the user information 7 including the user name matching the word with check as the target user information 7.

For instance, as illustrated in FIG. 6, it is supposed that a word NW3 “Yamada” is accompanied with a check image CG. In FIG. 6, the word NW3 is enclosed by a broken line. In this example, the word NW3 is accompanied with the check image CG, and hence the word NW3 is extracted as the word with check. Therefore, the user information 7 including the user name matching the word NW3 is recognized as the target user information 7. In other words, the user information 7 corresponding to the user having the name “Yamada” is recognized as the target user information 7. Note that the user can write the check image CG by hand writing.

Here, in the example shown in FIG. 6, it is supposed that a word NW4 “Sato” (the word NW4 is enclosed by a broken line) is also registered as a user name. In other words, it is supposed that the user information 7 including the word NW4 as a user name is stored in the storage unit 2. In this case, the word NW4 is not accompanied with the check image CG, and hence the user information 7 including the word NW4 as the user name is not recognized as the target user information 7. Although not illustrated, if the word NW4 is also accompanied with the check image CG in addition to the word NW3, the user information 7 including the word NW3 as the user name and the user information 7 including the word NW4 as the user name are both recognized as the target user information 7.

With reference to FIG. 3 again, after the process of Step S5, the process flow proceeds to Step S6. In Step S6, the control unit 1 sets the address associated with the user name included in the target user information 7 to the destination. In other words, the control unit 1 sets the address associated with the user name matching one of words listed in the name data (a word included in the text data) to the destination.

Here, if there are a plurality of target user information 7, the control unit 1 sets all the addresses respectively associated with the user names of the plurality of the target user information 7 to the destination. In addition, if there are a plurality of addresses associated with the user name in the target user information 7, the control unit 1 sets all the plurality of addresses to the destination.

In other words, if there are a plurality of target addresses to be set to the destination, the control unit 1 sets all the plurality of target addresses to the destination. Therefore, there is a case where a plurality of addresses are set to the destination (the image data of the document D may be transmitted to a plurality of addresses).

After setting of the destination, the process flow proceeds to Step S7. In Step S7, the control unit 1 transmits the image data to the destination set in the process of Step S6, using the communication unit 6.

In Step S1, if the control unit 1 determines that the automatic setting function is not enabled, the process flow proceeds to Step S8. When the process flow proceeds from Step S1 to Step S8, the automatic setting of the destination is not performed.

In Step S8, the control unit 1 determines whether or not an address is input to the transmission setting screen. As a result, if the control unit 1 determines that an address is input to the transmission setting screen, the process flow proceeds to Step S9. In Step S9, the control unit 1 controls the image reader unit 3 to read the document D.

After the document D is read, in Step S10, the control unit 1 sets the address input to the transmission setting screen to the destination. Further, in Step S11, the control unit 1 transmits the image data to the destination set in the process of Step S10, using the communication unit 6.

In Step S8, if the control unit 1 determines that an address is not input to the transmission setting screen, the process flow proceeds to Step S12. In Step S12, the control unit 1 controls the operation panel 5 to display a notification message that urges input of an address. After that, the process flow proceeds to Step S8. In other words, if the automatic setting function is not enabled, the user needs to input an address.

As described above, the multifunction peripheral 100 (image forming apparatus) of this embodiment includes the image reader unit 3 that reads the document D so as to generate the image data of the document D, the storage unit 2 that stores a user name and an address associated with the user name, the control unit 1 that performs a character recognition process on the image data of the document D so as to obtain text data from the image data of the document D, recognizes a word included in the text data, and sets the address associated with the user name matching the recognized word to a destination, and the communication unit 6 that transmits the image data of the document D to the destination set by the control unit 1.

In the structure of this embodiment, a user's desired address is associated with the user name and is stored in the storage unit 2 in advance. Thus, when transmitting the image data of the document D to the user's desired address, the control unit 1 automatically sets the user's desired address to a destination only by controlling the image reader unit 3 to read the document D in which the user name is written. In this way, the user is not required to input an address, and this is convenient.

In addition, if the first process is set to be performed, the control unit 1 recognizes a specific word included in text data obtained by performing a character recognition process on the image data of the document D, and sets an address associated with the user name matching a word on the same line as the specific word to the destination. In this structure, by writing the user name on the same line as the specific word (e.g. “creator”), the user's desired address is set to the destination. Here, the user usually writes a routine phrase such as “creator: xxx” (“xxx” is replaced with a user name of the sender) in the document D, and hence it is not a special work for the user to write the user name on the same line as the specific word. In other words, the user is not required to perform a special work.

In addition, if the second process is set to be performed, the control unit 1 recognizes a ruled line frame included in the image data of the document D. In other words, the control unit 1 recognizes a seal space area. Further, the control unit 1 sets an address associated with the user name matching a word inside the seal space area (ruled line frame) to the destination. In this structure, by putting a user's seal in the seal space area, the user's desired address is set to the destination. Here, in general, if there is a seal space area in the document D (such as an approval request document), the user puts his or her seal in the seal space area. As a result, a user name is in the seal space area. Therefore, the user is not required to perform a special work.

In addition, if the third process is set to be performed, the control unit 1 recognizes a specific image included in the image data of the document D. In other words, the control unit 1 recognizes a check image (a circular or elliptical frame image). Then, the control unit 1 sets the address associated with the user name matching a word accompanied with the check image (specific image) to the destination. In this structure, by attaching the check image to a user name written in the document D (a user name of the sender), a user's desired address is set to the destination. For instance, before executing the transmission job, the user is only required to enclose his or her user name written in the document D with a frame. In addition, the frame enclosing the user name may be written by hand. In this way, the simple work enables the multifunction peripheral 100 to perform the automatic setting of the destination.

In addition, if there are a plurality of target addresses (to be set to the destination), the control unit 1 sets all the plurality of target addresses to the destination. Thus, for example, in order to transmit the image data of the document D created by a plurality of users to the plurality of users' desired addresses, it is sufficient if user names of the plurality of users are written in the document D. In the first process, the user names written in the document D should be arranged on the same line as the specific word. In the second process, each of the users should put his or her seal in the seal space area in the document D. In the third process, each of the user name written in the document D should be enclosed by a frame.

Note that if there are a plurality of target addresses, it may be possible that the user selects an address to be set to the destination among the plurality of target addresses. For instance, if there are a plurality of target addresses, the control unit 1 controls the operation panel 5 to receive a selection operation of selecting one of the plurality of target addresses. Further, the control unit 1 sets the target address selected by the selection operation to the destination. In this structure, if there is a target address to not be selected to the destination among the plurality of target addresses, the target address can be excluded from the destination, and this is convenient for the user.

Here, the automatic setting function may be switched between enabled and disabled based on a format of the document D read by the image reader unit 3. If this structure is adopted, the storage unit 2 stores, in advance, specific format data of a specific format (e.g. a format of a routine document such as an approval request document or a bill).

Further, when the control unit 1 detects an operation to the start button in a state where the operation panel 5 displays the transmission setting screen, it controls the image reader unit 3 to read the document D. After the document D is read, the control unit 1 determines whether or not the read document D read by the image reader unit 3 is a specific format document D (such as an approval request document or a bill), based on the image data of the document D and the specific format data.

As a result of this determination, if it is determined that the read document D is a specific format document D, the control unit 1 sets the automatic setting function to be enabled. In this case, the control unit 1 performs the process of Steps S3 to S7 of the flowchart shown in FIG. 3. In contrast, if it is determined that the read document D is not a specific format document D, the control unit 1 sets the automatic setting function to be disabled. In this case, the control unit 1 performs the process of Steps S8 and S10 to S12 of the flowchart shown in FIG. 3. The process of Step S2 and the process of Step S9 are omitted because the document D is already read.

In this structure, it is not necessary to set the automatic setting function to be enabled or disabled, and convenience for the user is improved.

The embodiment disclosed in this specification is merely an example in every aspect and should not be interpreted as a limitation. The scope of the present disclosure is defined not by the above description of the embodiment but by the claims, and should be understood to include all modifications within meanings and scope equivalent to the claims.

What is claimed is:

1. An image forming apparatus comprising:
an image reader unit arranged to read a document so as to generate image data;
a storage unit arranged to store a user name and an address associated with the user name;
a control unit arranged to perform a character recognition process on the image data so as to obtain text data from the image data, recognize a word included in the text data, and set the address associated with the user name matching the recognized word to a destination; and
a communication unit arranged to transmit the image data to the destination set by the control unit.

2. The image forming apparatus according to claim 1, wherein the control unit recognizes a specific word included in the text data, and sets the address associated with the user name matching a word on the same line as the specific word to the destination.

3. The image forming apparatus according to claim 1, wherein the control unit recognizes a ruled line frame included in the image data, and sets the address associated with the user name matching a word inside the ruled line frame to the destination.

4. The image forming apparatus according to claim 1, wherein the control unit recognizes a specific image included in the image data, and sets the address associated with the user name matching a word accompanied with the specific image to the destination.

5. The image forming apparatus according to claim 1, wherein if there are a plurality of target addresses as the address to be set to the destination, the control unit sets all the plurality of target addresses to the destination.

6. The image forming apparatus according to claim 1, further comprising an operation panel, wherein
if there are a plurality of target addresses as the address to be set to the destination, the control unit controls the operation panel to receive a selection operation of selecting one of the plurality of target addresses, and sets the target address selected by the selection operation to the destination.

7. The image forming apparatus according to claim 1, wherein
the control unit determines based on the image data whether or not a read document read by the image reader unit is a specific format document, and
if the read document is the specific format document, the control unit sets the address associated with the user name matching the word to the destination.
